(19) United States
(12) Patent Application Publication
(10) Pub. No.: US 2023/0209369 A1
(43) Pub. Date: Jun. 29, 2023

(54) ANTENNA DEVICE

(71) Applicant: Panasonic Intellectual Property Management Co., Ltd., Osaka (JP)

(72) Inventors: Kiyokazu SHIKANO, KANAGAWA KEN (JP); Eiichi KURAISHI, KANAGAWA KEN (JP); Shigeaki SAKURAZAWA, KANAGAWA KEN (JP); Daishi IWAMOTO, KANAGAWA KEN (JP)

(73) Assignee: Panasonic Intellectual Property Management Co., Ltd., Osaka (JP)

(21) Appl. No.: 17/979,515

(22) Filed: Nov. 2, 2022

(30) Foreign Application Priority Data
Dec. 24, 2021 (JP) 2021-211056

(51) Int. Cl. H04W 24/02; H01Q 1/32; B60R 16/023; G07C 5/02

(52) U.S. Cl. CPC H04W 24/02; H01Q 1/3275; B60R 16/023; G07C 5/02

(57) ABSTRACT

An antenna device is mounted on a vehicle and performs vehicle-to-vehicle and road-to-vehicle communications using a plurality of communicators including antennas. The antenna device includes one or more hardware processors coupled to one or more memories, and configured to function as, communication control units, a vehicle state detection unit, and operation control units. Communication control units are each provided in one of the plurality of communicators and control transmission/reception operations of the antennas connected to the communicators. A vehicle state detection unit detects a state of the vehicle and operation states of the communication control units. Operation control units are each provided in one of the plurality of communicators and control the operation states of the communication control units according to the state of the vehicle detected by the vehicle state detection unit and the operation states of the communication control units, for each of the plurality of communicators.

### CROSS-REFERENCE TO RELATED APPLICATIONS

This application is based upon and claims the benefit of priority from Japanese Patent Application No. 2021-211056, filed Dec. 24, 2021, the entire contents of which are incorporated herein by reference.

### FIELD

The present disclosure relates to an antenna device.

### BACKGROUND

In recent years, demand for connected cars has increased, and a vehicle to X (V2X) technology for performing communication between a vehicle and another vehicle, a pedestrian, a roadside unit, or the like has been developed. U.S. patent Ser. No. 10/779,140 discloses an antenna device including a central control unit and a plurality of communication units.

U.S. patent Ser. No. 10/779,140 discloses a use case of simultaneously controlling all communication units and a use case of controlling only selected individual communication units, but does not mention a switching trigger for switching control timings of the use cases.

An object of the present disclosure is to provide an antenna device capable of switching an operation state of each communication unit with an appropriate switching trigger.

### SUMMARY

An antenna device according to the present disclosure is mounted on a vehicle and performs vehicle-to-vehicle communication and road-to-vehicle communication using a plurality of communicators including antennas. The antenna device includes one or more memories, and one or more hardware processors coupled to the one or more memories. The one or more hardware processors being configured to function as communication control units, a vehicle state detection unit, and operation control units. The communication control units are each provided in one of the plurality of communicators and control transmission/reception operations of the antennas connected to the communicators. The vehicle state detection unit detects a state of the vehicle and operation states of the communication control units. the operation control units are each provided in one of the plurality of communicators and control the operation states of the communication control units according to the state of the vehicle detected by the vehicle state detection unit and the operation states of the communication control units, for each of the plurality of communicators.

### BRIEF DESCRIPTION OF THE DRAWINGS

FIG. 1 is a diagram illustrating an example in which an antenna device according to an embodiment is mounted on a vehicle;

FIG. 2 is a functional block diagram illustrating an example of a functional configuration of the antenna device according to the embodiment;

FIG. 3 is a first sequence diagram illustrating an example of a flow of processing executed by the antenna device according to the embodiment;

FIG. 4 is a second sequence diagram illustrating an example of a flow of processing executed by the antenna device according to the embodiment;

FIG. 5 is a flowchart illustrating an example of a flow of vehicle state and communication unit operation state determination processing executed by the antenna device according to the embodiment;

FIG. 6 is a flowchart illustrating an example of a flow of temperature measurement cycle determination processing executed by the antenna device according to the embodiment;

FIG. 7A is a first flowchart illustrating an example of a flow of communication unit cooling ON/OFF determination processing performed by a cooling control unit of the antenna device according to the embodiment;

FIG. 7B is a second flowchart illustrating an example of the flow of the communication unit cooling ON/OFF determination processing performed by the cooling control unit of the antenna device according to the embodiment; and

FIG. 7C is a third flowchart illustrating an example of the flow of the communication unit cooling ON/OFF determination processing performed by the cooling control unit of the antenna device according to the embodiment.

### DETAILED DESCRIPTION

Hereinafter, an antenna device according to the present disclosure will be described with reference to the drawings.

Schematic Configuration of Antenna Device

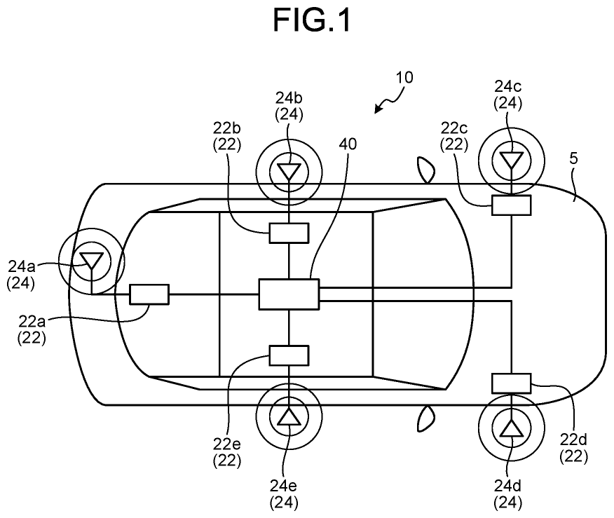

A schematic configuration of an antenna device 10 will be described with reference to FIG. 1. FIG. 1 is a diagram illustrating an example in which an antenna device according to an embodiment is mounted on a vehicle.

The antenna device 10 is mounted on a vehicle 5 and includes a central control unit 40 and a plurality of communication units (communicators) 22a, 22b, 22c, 22d, and 22e. Hereinafter, the plurality of communication units 22a, 22b, 22c, 22d, and 22e are collectively referred to as a communication unit 22.

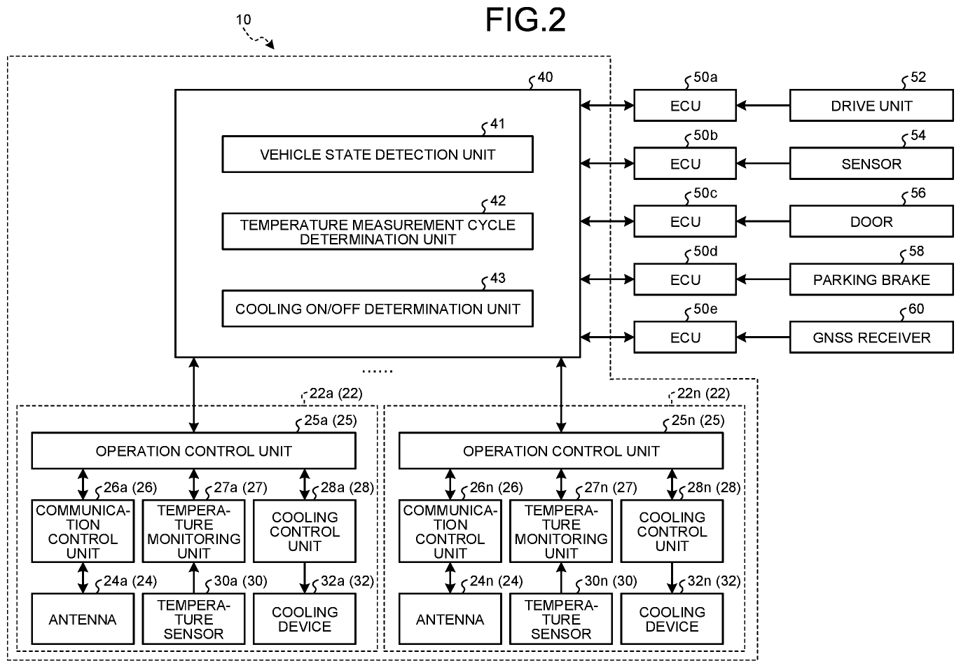

The central control unit 40 acquires an operation state of each unit of the vehicle 5 and detects a state of the vehicle 5. Details will be described later (see FIG. 2). In addition, the central control unit 40 communicates with the communication unit 22 to acquire the operation state of the communication unit 22. In addition, the central control unit 40 individually controls the operation state of each of the communication units 22 based on the state of the vehicle 5 and the operation state of each of the communication units 22. Furthermore, the central control unit 40 sets a cycle for measuring the temperature of the operating communication unit among the communication units 22. In addition, the central control unit 40 instructs the operating communication unit to turn ON/OFF a cooling device 32 (see FIG. 2) that cools the communication unit.

The communication units 22a, 22b, 22c, 22d, and 22e include antennas 24a, 24b, 24c, 24d, and 24e respectively connected to the communication units 22a, 22b, 22c, 22d, and 22e. Hereinafter, the plurality of antennas 24a, 24b, 24c, 24d, and 24e are collectively referred to as an antenna 24.

The communication unit 22 and the antenna 24 are installed on the roof, trunk lid, or the like of the vehicle 5. The communication unit 22 and the antenna 24 perform wireless communication with another vehicle or a roadside unit that exists around the vehicle 5 and has communication equipment having a communication function, a pedestrian that has communication equipment having a communication function, or a communication network around the vehicle 5. The vehicle 5 acquires information necessary for driving assistance and automatic driving by performing such wireless communication. In addition, various software of the vehicle 5 and a database such as map data are updated. In addition, the presence of the vehicle 5 is notified from the vehicle 5 to the outside.

In general, a plurality of communication units 22 and antennas 24 are installed in the vehicle 5 so that the vehicle 5 can communicate with communication equipment in a range as wide as possible. The installation location and the number of installations are appropriately determined for each vehicle type.

Furthermore, the communication unit 22 monitors its own temperature during operation. Furthermore, in a case where the communication unit 22 is operating, the communication unit 22 controls ON/OFF of a cooling unit that cools the communication unit upon receiving an instruction from the central control unit 40.

The antenna 24 receives a radio wave related to the application of V2X mounted on the vehicle 5 from the outside of the vehicle 5, and transmits a radio wave related to the application of V2X mounted on the vehicle 5 to the outside of the vehicle 5. Note that a specific configuration of the antenna 24 is not limited.

Functional Configuration of Antenna Device

A functional configuration of the antenna device 10 will be described with reference to FIG. 2. FIG. 2 is a functional block diagram illustrating an example of a functional configuration of the antenna device according to the embodiment.

The antenna device 10 includes the central control unit 40 and the communication units 22a, . . . , 22n.

The central control unit 40 is connected to each unit of the vehicle 5 and acquires information on the state of the vehicle 5. Specifically, the central control unit 40 acquires information on an operation state of a drive unit 52 via an ECU 50a. The drive unit 52 is, for example, an engine or a motor that drives the vehicle 5. In addition, the central control unit 40 acquires information detected by a sensor 54 via an ECU 50b. The sensor 54 is, for example, a seating sensor or the like that detects whether an occupant is seated on a driver's seat of the vehicle 5. In addition, the central control unit 40 acquires information on a state of a door 56 via an ECU 50c. The information on the state of the door 56 is, for example, information indicating an open/closed state of the door 56. The central control unit 40 also acquires information on a state of a parking brake 58 via an ECU 50d. The information on the state of the parking brake 58 is, for example, information indicating whether or not the parking brake 58 is operated. In addition, the central control unit 40 acquires, via an ECU 50e, current position information of the vehicle 5 calculated by a car navigation device of the vehicle 5 on the basis of information received by a global navigation satellite system (GNSS) receiver 60, more precisely, information received by the GNSS receiver 60.

The central control unit 40 has a configuration of a computer incorporating a central processing unit (CPU) (not illustrated). The central control unit 40 realizes a vehicle state detection unit 41, a temperature measurement cycle determination unit 42, and a cooling ON/OFF determination unit 43 as functional units by the CPU executing a control program.

The vehicle state detection unit 41 detects the state of the vehicle 5 and the operation state of the communication unit 22. The vehicle state detection unit 41 causes an operation control unit 25 to start or stop the transmission/reception operation of the antenna 24 connected to the operation control unit 25.

The temperature measurement cycle determination unit 42 determines a cycle of measuring the temperature of the communication unit 22 with respect to the operating communication unit 22. More specifically, the temperature measurement cycle determination unit 42 determines the operating communication unit 22 to have a shorter cycle when the cooling device 32 connected to the communication unit 22 is ON, that is, when cooling is performed, as compared with a case where the cooling device 32 connected to the communication unit 22 in operation is OFF, that is, when cooling is not performed. In addition, the temperature measurement cycle determination unit 42 notifies the corresponding communication unit 22 of a temperature measurement timing at the determined temperature measurement cycle. The temperature measurement cycle determination unit 42 also receives a temperature measurement result from the communication unit 22.

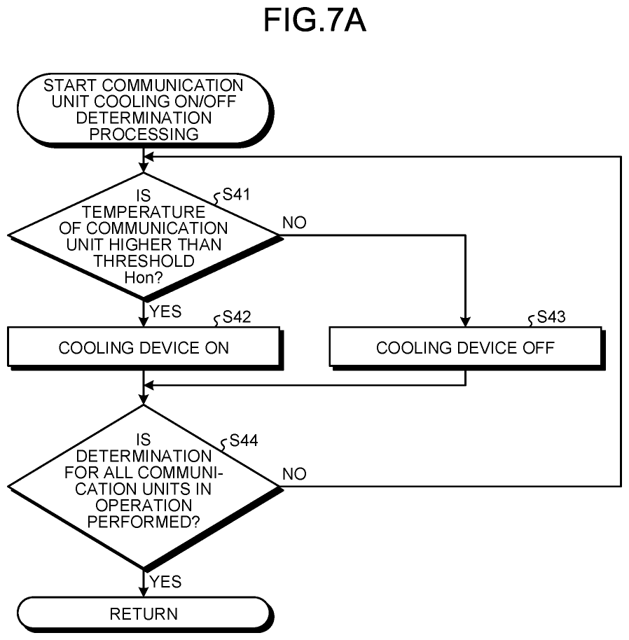

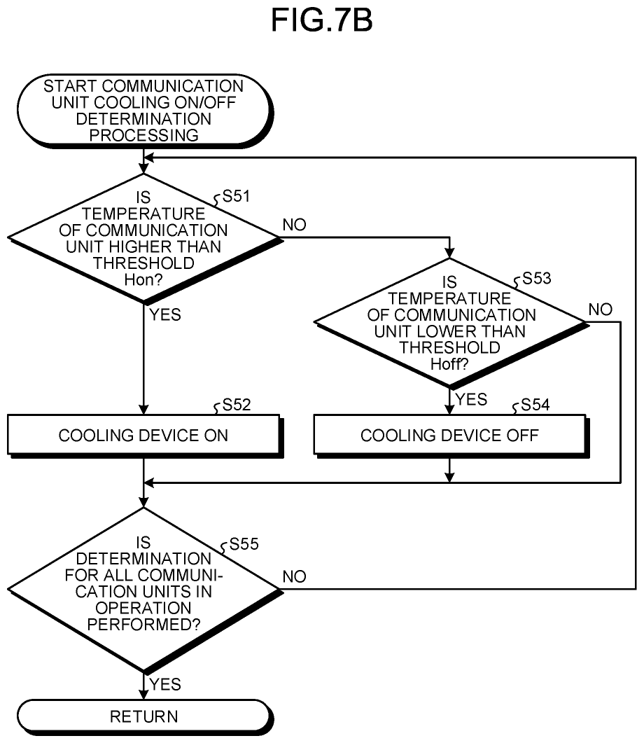

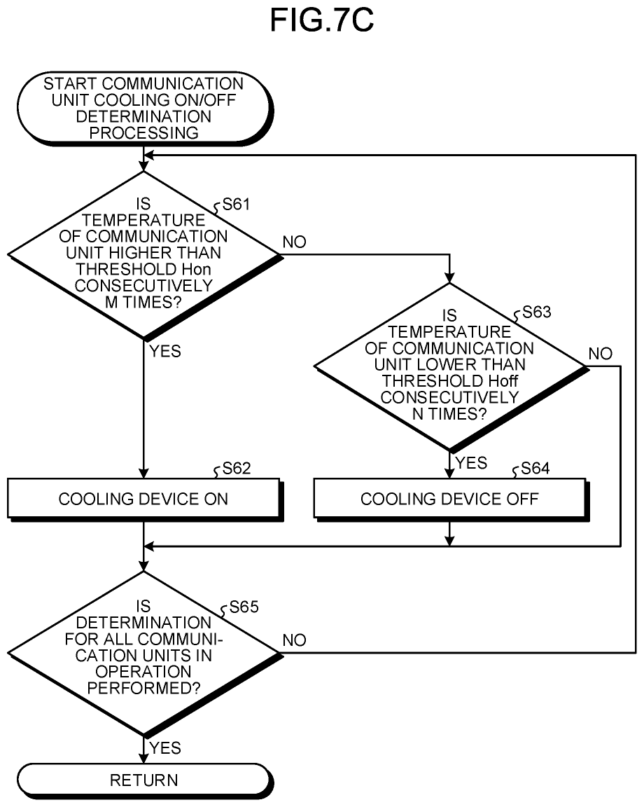

When detecting that the temperature of the communication unit 22 received by the temperature measurement cycle determination unit 42 is higher than the first predetermined value Hon (see FIG. 7B), the cooling ON/OFF determination unit 43 starts cooling the communication unit 22. When the cooling ON/OFF determination unit 43 detects that the temperature of the communication unit 22 received by the temperature measurement cycle determination unit 42 is lower than a second predetermined value Hoff (see FIG. 7B) that is equal to or lower than the first predetermined value Hon, the cooling ON/OFF determination unit stops cooling the communication unit 22. Note that the first predetermined value Hon and the second predetermined value Hoff may be the same value. Hereinafter, in order to simplify the description, the first predetermined value Hon and the second predetermined value Hoff are referred to as a threshold Hon and a threshold Hoff, respectively.

The communication unit 22 has a configuration of a computer incorporating a CPU (not illustrated). The CPU executes the control program, whereby the communication unit 22 implements the operation control unit 25, a communication control unit 26, a temperature monitoring unit 27, and a cooling control unit 28 as functional units. Note that, in the following description, in a case where it is necessary to distinguish and describe the operation control unit 25, the communication control unit 26, the temperature monitoring unit 27, and the cooling control unit 28 included in each of the plurality of communication units 22a, . . . , and 22n, each functional part included in the communication unit 22n will be described with a subscript n of the corresponding communication unit. For example, the communication control unit included in the communication unit 22n is represented by reference numeral 26n.

The operation control unit 25 is included in each communication unit 22, and controls the operation state of the communication control unit 26 for each communication unit according to the state of the vehicle 5 detected by the vehicle state detection unit 41 and the operation state of the communication control unit 26.

For example, when the vehicle state detection unit 41 detects that the vehicle 5 is traveling in a closed space such as a tunnel or an underground parking, the operation control unit 25 stops the transmission/reception operation of the communication control unit 26 connected to the predetermined antenna 24 among the plurality of communication control units 26. More specifically, the transmission/reception operation is stopped except for the antenna 24 having the transmission/reception range in a traveling direction of the vehicle 5 and a rear side in the traveling direction of the vehicle 5.

In addition, as an example for determining the presence or absence of vehicle-to-vehicle communication, the operation control unit 25 determines that communication is unavailable on condition that the vehicle state detection unit 41 determines that a communication frequency of the communication control unit 26 is lower than a predetermined value, and stops the transmission/reception operation of the antenna 24 connected to the communication control unit 26.

When the vehicle state detection unit 41 detects that the vehicle 5 is stopped, the operation control unit 25 stops the transmission/reception operation of the communication control unit 26 connected to the predetermined antenna 24 among the plurality of communication control units 26.

Note that the above-described example is an example of the function of the operation control unit 25, and the function of the operation control unit 25 is not limited thereto. In addition, the transmission/reception operation of the antenna 24 may be appropriately controlled according to the state of the vehicle 5 and the operation state of the communication control unit 26.

The communication control unit 26 is included in each of the communication units 22, and controls the transmission/reception operation of the antenna 24 connected to the communication unit 22.

The temperature monitoring unit 27 causes the communication unit 22 in which the communication control unit 26 causes the antenna 24 to perform the transmission/reception operation to monitor the temperature at a predetermined cycle.

The cooling control unit 28 controls the cooling device 32 based on the determination result of the cooling ON/OFF determination unit 43.

The antenna 24, a temperature sensor 30, and the cooling device 32 are connected to the communication unit 22.

The antenna 24 transmits and receives information on the V2X application mounted on the vehicle 5 as a radio wave.

The temperature sensor 30 is a sensor that measures the temperature of the communication unit 22. As the temperature sensor 30, for example, a thermistor or a thermocouple is used.

The cooling device 32 cools the communication unit 22. The cooling device 32 is, for example, a cooling fan. As cooling device 32, a thermoelectric element such as a Peltier element may be used.

Flow of Processing Performed by Antenna Device

### (Simultaneous Control of Plurality of Communication Units)

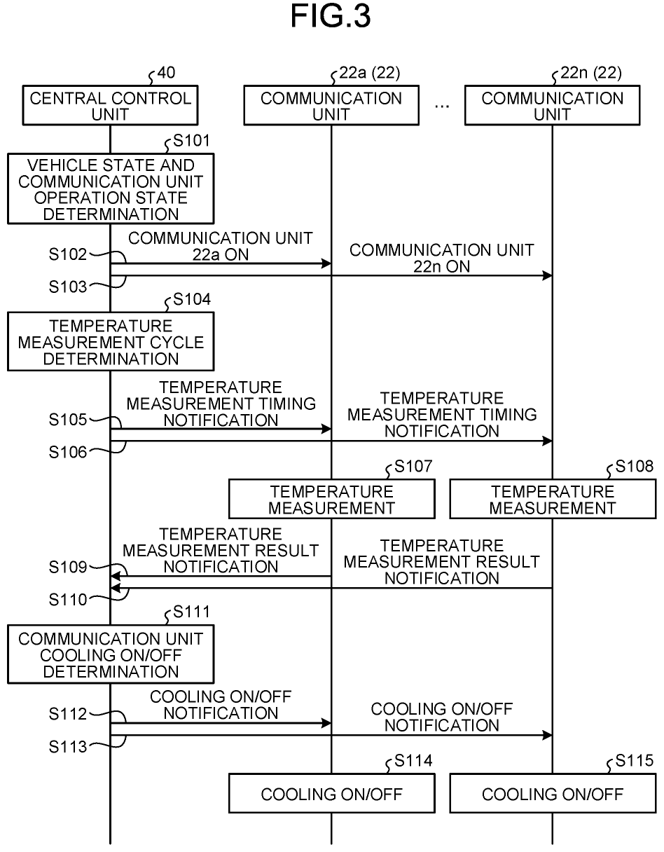

An example of a flow of processing executed by the antenna device 10 will be described with reference to FIG. 3. FIG. 3 is a first sequence diagram illustrating an example of the flow of processing executed by the antenna device according to the embodiment. In particular, FIG. 3 illustrates an example in which the central control unit 40 notifies all the communication units 22 (22a, . . . , 22n) connected to the central control unit 40 of an operation start instruction or an operation stop instruction. It is assumed that all the communication units 22 are in the operation state as an initial state.

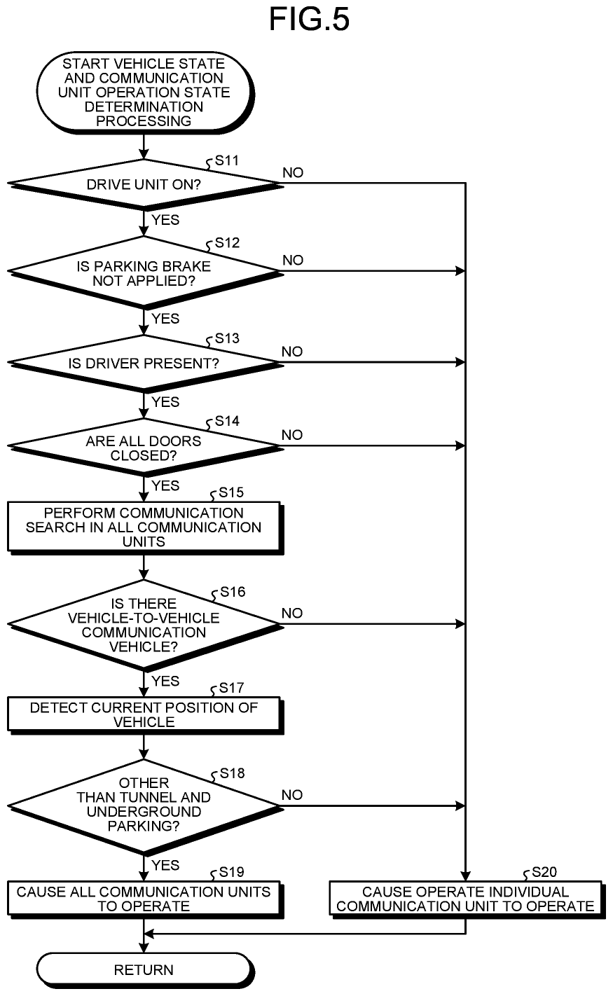

The vehicle state detection unit 41 of the central control unit 40 performs determination processing of determining the vehicle state of the vehicle 5 and the operation state of the communication unit 22 (Step S101). Note that a specific flow of the processing performed in Step S101 will be described later (see FIG. 5). Hereinafter, assuming that the central control unit 40 determines to operate all the communication units 22 in Step S101, the flow of subsequent processing will be described.

The vehicle state detection unit 41 of the central control unit 40 causes the communication unit 22a to start a transmission/reception operation of the antenna 24a (Step S102). Furthermore, the central control unit 40 causes the communication unit 22n to start a transmission/reception operation of the antenna 24n (Step S103). Note that, at this time, since all the communication units 22 are operating, the communication unit 22a does nothing even when receiving the instruction in Step S102. Furthermore, the communication unit 22n does nothing even when receiving the instruction in Step S103.

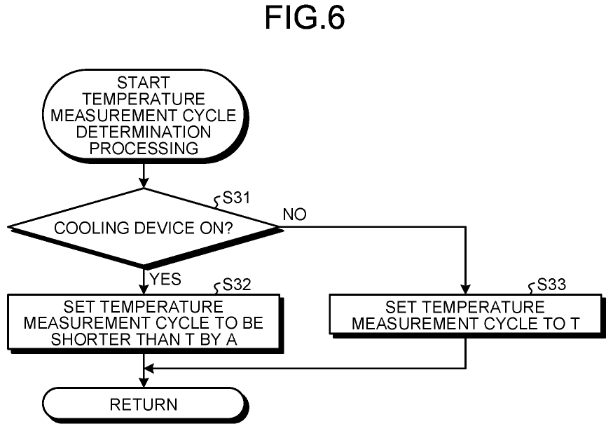

The temperature measurement cycle determination unit 42 of the central control unit 40 performs determination processing of determining the temperature measurement cycle of the communication unit 22 (Step S104). Note that a specific flow of the processing performed in Step S104 will be described later (see FIG. 6).

The temperature measurement cycle determination unit 42 of the central control unit 40 notifies the communication unit 22a of an instruction on the temperature measurement timing of the communication unit 22a (Step S105). Furthermore, the central control unit 40 notifies the communication unit 22n of an instruction on the temperature measurement timing of the communication unit 22n (Step S106).

Upon receiving the notification of the temperature measurement timing in Step S105, the temperature monitoring unit 27a of the communication unit 22a monitors the output of a temperature sensor 30a to measure the temperature (Step S107). Upon receiving the notification of the temperature measurement timing in Step S106, a temperature monitoring unit 27n of the communication unit 22n monitors the output of a temperature sensor 30n to measure the temperature (Step S108).

The temperature monitoring unit 27a of the communication unit 22a notifies the central control unit 40 of the measurement result of the temperature. Then, the temperature measurement cycle determination unit 42 of the central control unit 40 receives the notification of the temperature measurement result from the communication unit 22a (Step S109). In addition, the temperature monitoring unit 27n of the communication unit 22n notifies the central control unit 40 of the measurement result of the temperature. Then, the central control unit 40 receives a notification of the temperature measurement result from the communication unit 22n (Step S110).

The cooling ON/OFF determination unit 43 of the central control unit 40 performs cooling ON/OFF determination processing of determining whether to start cooling or stop cooling of the communication unit 22 according to the temperature of the communication unit 22 (Step S111). Note that a specific flow of the processing performed in Step S111 will be described later (See FIGS. 7A, 7B, and 7C).

The cooling ON/OFF determination unit 43 of the central control unit 40 notifies the communication unit 22a of an instruction to start or stop cooling (Step S112). The cooling ON/OFF determination unit 43 of the central control unit 40 notifies the communication unit 22n of an instruction to start or stop cooling (Step S113).

Upon receiving the notification instructing to start or stop the cooling in Step S112, the cooling control unit 28a of the communication unit 22a starts or stops the cooling of the communication unit 22a (Step S114). Upon receiving the notification instructing to start or stop the cooling in Step S113, a cooling control unit 28n of the communication unit 22n starts or stops the cooling of the communication unit 22n (Step S115). Thereafter, the antenna device 10 repeats the processing of FIG. 3.

Flow of Processing Performed by Antenna Device

### (Individual Control of Plurality of Communication Units)

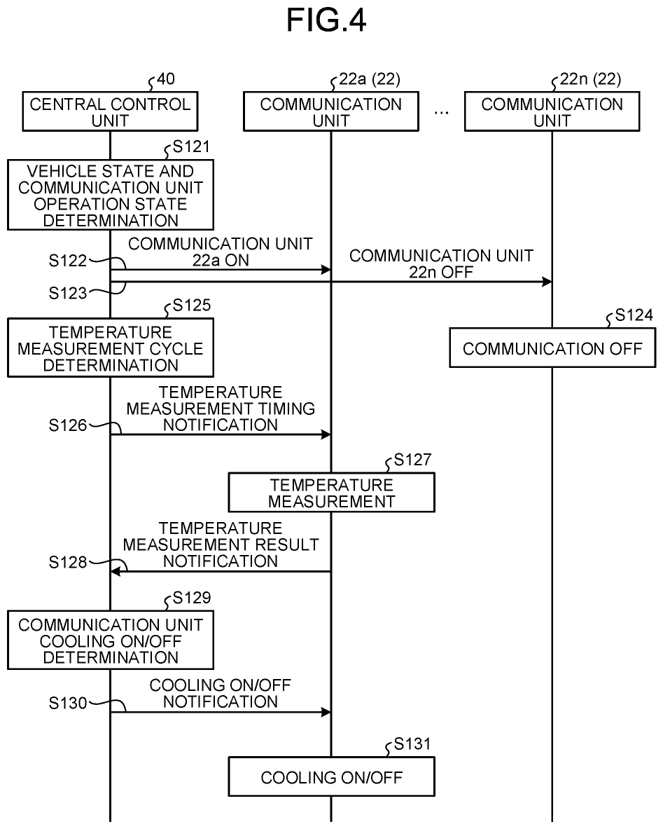

An example of a flow of processing executed by the antenna device 10 will be described with reference to FIG. 4. FIG. 4 is a second sequence diagram illustrating an example of the flow of the processing executed by the antenna device according to the embodiment. In particular, FIG. 4 illustrates an example in which the central control unit 40 individually notifies the communication unit 22 (22a, . . . , 22n) connected to the central control unit 40 of an operation start instruction or an operation stop instruction. It is assumed that all the communication units 22 are in the operation state as an initial state.

The vehicle state detection unit 41 of the central control unit 40 performs determination processing of determining the vehicle state of the vehicle 5 and the operation state of the communication unit 22 (Step S121). Note that a specific flow of the processing performed in Step S121 will be described later (see FIG. 5). Hereinafter, assuming that the central control unit 40 determines to cause the communication unit 22a to operate and to stop the communication unit 22n in Step S121, a flow of subsequent processing will be described.

The vehicle state detection unit 41 of the central control unit 40 causes the communication unit 22a to start a transmission/reception operation of the antenna 24a (Step S122). Furthermore, the central control unit 40 causes the communication unit 22n to stop the transmission/reception operation of the antenna 24n (Step S123). Note that, at this time, since all the communication units 22 are operating, the communication unit 22a does nothing even when receiving the instruction in Step S102. Meanwhile, an operation control unit 25n of the communication unit 22n causes the communication control unit 26n to stop transmission and reception of the antenna 24n (Step S124).

The temperature measurement cycle determination unit 42 of the central control unit 40 performs determination processing of determining the temperature measurement cycle of the communication unit 22 (Step S125). Note that a specific flow of the processing performed in Step S125 will be described later (see FIG. 6).

The temperature measurement cycle determination unit 42 of the central control unit 40 notifies the communication unit 22a of an instruction on the temperature measurement timing of the communication unit 22a (Step S126). Since the communication unit 22n has stopped operating, the temperature measurement cycle determination unit 42 of the central control unit 40 does not notify the communication unit 22n of the instruction of the temperature measurement timing.

Upon receiving the notification of the temperature measurement timing in Step S126, the temperature monitoring unit 27a of the communication unit 22a monitors the output of the temperature sensor 30a to measure the temperature (Step S127).

The temperature monitoring unit 27a of the communication unit 22a notifies the central control unit 40 of the measurement result of the temperature. Then, the temperature measurement cycle determination unit 42 of the central control unit 40 receives the notification of the temperature measurement result from the communication unit 22a (Step S128).

The cooling ON/OFF determination unit 43 of the central control unit 40 performs cooling ON/OFF determination processing of determining whether to start cooling or stop cooling of the communication unit 22 according to the temperature of the communication unit 22 (Step S129). Note that a specific flow of the processing performed in Step S129 will be described later (See FIGS. 7A, 7B, and 7C).

The cooling ON/OFF determination unit 43 of the central control unit 40 notifies the communication unit 22a of an instruction to start or stop cooling (Step S130). Note that since the cooling ON/OFF determination unit 43 of the central control unit 40 has not received the measurement result of the temperature from the communication unit 22n, nothing is notified to the communication unit 22n.

Upon receiving the notification instructing to start or stop the cooling in Step S130, the cooling control unit 28a of the communication unit 22a starts or stops the cooling of the communication unit 22a (Step S131). Thereafter, the antenna device 10 repeats the processing of FIG. 4. Which communication unit in the communication unit 22 is operated and which communication unit is stopped is changed depending on the detection result of the vehicle state detection unit 41 at that time.

Vehicle State and Flow of Communication Unit Operation State Determination Processing

A flow of determination processing of the vehicle state and the communication unit operation state performed in Step S101 in FIG. 3 and Step S121 in FIG. 4 will be described with reference to FIG. 5. FIG. 5 is a flowchart illustrating an example of a flow of the vehicle state and the communication unit operation state determination processing executed by the antenna device according to the embodiment.

The vehicle state detection unit 41 determines whether the drive unit 52 is ON, that is, in the operation state (Step S11). When it is determined that the drive unit 52 is ON (Step S11: Yes), the process proceeds to Step S12. Meanwhile, when it is not determined that the drive unit 52 is ON (Step S11: No), the process proceeds to Step S20. Whether the drive unit 52 is ON is determined based on the output of the drive unit 52 acquired by the vehicle state detection unit 41 through the ECU 50a.

When it is determined in Step S11 that the drive unit 52 is ON, the vehicle state detection unit 41 determines whether the parking brake 58 of the vehicle 5 is not applied (Step S12). When it is determined that the parking brake 58 of the vehicle 5 is not applied (Step S12: Yes), the process proceeds to Step S13. Meanwhile, when it is not determined that the parking brake 58 of the vehicle 5 is not applied (Step S12: No), the process proceeds to Step S20. Whether the parking brake 58 of the vehicle 5 is not applied is determined by the vehicle state detection unit 41 based on the output of the parking brake 58 acquired via the ECU 50d.

When it is determined in Step S12 that the parking brake 58 of the vehicle 5 is not applied, the vehicle state detection unit 41 determines whether the driver is in a driver's seat of the vehicle 5 (Step S13). When it is determined that the driver is in the driver's seat of the vehicle 5 (Step S13: Yes), the process proceeds to Step S14. Meanwhile, when it is not determined that the driver is in the driver's seat of the vehicle 5 (Step S13: No), the process proceeds to Step S20. Whether the driver is in the driver's seat of the vehicle 5 is determined by the vehicle state detection unit 41 based on the output of the sensor 54 (for example, a seating sensor) acquired via the ECU 50b.

When it is determined in Step S13 that the driver is in the driver's seat of the vehicle 5, the vehicle state detection unit 41 determines whether all the doors of the vehicle 5 are closed (Step S14). When it is determined that all the doors of the vehicle 5 are closed (Step S14: Yes), the process proceeds to Step S15. Meanwhile, when it is not determined that all the doors of the vehicle 5 are closed (Step S14: No), the process proceeds to Step S20. Whether all the doors of the vehicle 5 are closed is determined by the vehicle state detection unit 41 on the basis of the output of information on the state of the doors 56 (for example, information indicating open/closed states of the doors 56) acquired via the ECU 50c.

When it is determined in Step S14 that all the doors of the vehicle 5 are closed, the vehicle state detection unit 41 causes the operation control units 25 of all the communication units 22 to search for the communication state of each communication unit 22 (Step S15).

Furthermore, the vehicle state detection unit 41 determines whether there is a vehicle that is performing vehicle-to-vehicle communication with the antenna device 10 on the basis of the result of Step S15 (Step S16). When it is determined that there is a vehicle that is performing vehicle-to-vehicle communication with the antenna device 10 (Step S15: Yes), the process proceeds to Step S17.

Meanwhile, when it is not determined that there is a vehicle that is performing vehicle-to-vehicle communication with the antenna device 10 (Step S15: No), the process proceeds to Step S20. As described above, the absence of a vehicle performing vehicle-to-vehicle communication may be determined by determining that communication is unavailable when the communicator reception level is lower than a predetermined value, for example.

When it is determined in Step S16 that there is a vehicle that is performing vehicle-to-vehicle communication with the antenna device 10, the vehicle state detection unit 41 detects the current position of the vehicle 5 on the basis of the reception information of the GNSS receiver 60 acquired via the ECU 50e (Step S17).

Subsequently, the vehicle state detection unit 41 determines whether the current position of the vehicle 5 detected in Step S17 is other than a tunnel or an underground parking (Step S18). When it is determined that the current position of the vehicle 5 is other than the tunnel or the underground parking (Step S18: Yes), the process proceeds to Step S19. Meanwhile, when it is not determined that the current position of the vehicle 5 is other than the tunnel or the underground parking (Step S18: No), the process proceeds to Step S20.

When it is determined in Step S18 that the current position of the vehicle 5 is other than the tunnel or the underground parking, the vehicle state detection unit 41 causes the operation control unit 25 to cause all the communication units 22 to operate (Step S19). Thereafter, the sequence returns to the sequence diagram of FIG. 3 or FIG. 4.

When it is determined in Steps S11, S12, S13, S14, S16, and S18 that the condition is not satisfied, vehicle state detection unit 41 causes the operation control unit 25 to cause an individual communication unit of the communication units 22 to operate (Step S20). Which communication unit is made operate is appropriately set.

Flow of Temperature Measurement Cycle Determination Processing

The flow of the temperature measurement cycle determination processing performed in Step S104 in FIG. 3 and Step S125 in FIG. 4 will be described with reference to FIG. 6. FIG. 6 is a flowchart illustrating an example of the flow of the temperature measurement cycle determination processing executed by the antenna device according to the embodiment.

The temperature measurement cycle determination unit 42 determines whether the cooling device 32 of each communication unit 22 is ON (Step S31). When it is determined that the cooling device 32 of the communication unit 22 is ON (Step S31: Yes), the process proceeds to Step S32. Meanwhile, when it is not determined that the cooling device 32 of the communication unit 22 is ON (Step S31: No), the process proceeds to Step S33. In Step S31, the temperature measurement cycle determination unit 42 may determine whether the cooling device 32 is ON only for the communication unit 22 in operation.

When it is determined in Step S31 that the cooling device 32 of the communication unit 22 is ON, the temperature measurement cycle determination unit 42 notifies the communication unit 22 in which the cooling device 32 is ON of the temperature measurement timing by setting the temperature measurement cycle to be shorter than the temperature measurement cycle T in a case where the cooling device 32 is OFF by a predetermined time A (Step S32). Thereafter, the sequence returns to the sequence diagram of FIG. 3 or FIG. 4.

Meanwhile, when it is not determined in Step S31 that the cooling device 32 of the communication unit 22 is ON, the temperature measurement cycle determination unit 42 notifies the communication unit 22 in which the cooling device 32 is not ON of the temperature measurement timing at the temperature measurement cycle T. Thereafter, the sequence returns to the sequence diagram of FIG. 3 or FIG. 4.

Note that the value of the temperature measurement cycle T in a case where the cooling device 32 of the communication unit 22 is OFF and the value of the predetermined time A for making the temperature measurement cycle shorter in a case where the cooling device 32 of the communication unit 22 is ON than the temperature measurement cycle T in a case where the cooling device 32 of the communication unit 22 is OFF may be appropriately set.

Flow of Communication Unit Cooling ON/OFF Determination Processing (1)

A first example of a flow of the communication unit cooling ON/OFF determination processing performed in Step S111 in FIG. 3 and Step S129 in FIG. 4 will be described with reference to FIG. 7A. FIG. 7A is a first flowchart illustrating an example of the flow of the communication unit cooling ON/OFF determination processing performed by the cooling control unit of the antenna device according to the embodiment.

The cooling ON/OFF determination unit 43 determines whether the temperature of the communication unit 22 acquired from the temperature monitoring unit 27 of the communication unit 22 is higher than the threshold Hon (Step S41). When it is determined that the temperature of the communication unit 22 is higher than the threshold Hon (Step S41: Yes), the process proceeds to Step S42. Meanwhile, when it is not determined that the temperature of the communication unit 22 is higher than the threshold Hon (Step S41: No), the process proceeds to Step S43. Note that the cooling ON/OFF determination unit 43 may determine the temperature of the communication unit 22 only for the communication unit 22 in operation.

When it is determined in Step S41 that the temperature of the communication unit 22 is higher than the threshold Hon, the cooling ON/OFF determination unit 43 turns ON the cooling device 32 connected to the communication unit 22 (Step S42). Thereafter, the process proceeds to Step S44.

Meanwhile, when it is not determined in Step S41 that the temperature of the communication unit 22 is higher than the threshold Hon, the cooling ON/OFF determination unit 43 turns OFF the cooling device 32 connected to the communication unit 22 (Step S43). Thereafter, the process proceeds to Step S44.

Subsequent to Step S42 or Step S43, the cooling ON/OFF determination unit 43 determines whether the temperatures of all the communication units 22 in operation have been checked (Step S44). When it is determined that the temperatures of all the communication units 22 in operation have been checked (Step S44: Yes), the process returns to the sequence diagram of FIG. 3 or FIG. 4. Meanwhile, when it is not determined that the temperatures of all the communication units 22 in operation have been checked (Step S44: No), the process returns to Step S41.

Flow of Communication Unit Cooling ON/OFF Determination Processing (2)

A second example of the flow of the communication unit cooling ON/OFF determination processing performed in Step S111 of FIG. 3 and Step S129 of FIG. 4 will be described with reference to FIG. 7B. FIG. 7B is a second flowchart illustrating an example of the flow of the communication unit cooling ON/OFF determination processing performed by the cooling control unit of the antenna device according to the embodiment.

The cooling ON/OFF determination unit 43 determines whether the temperature of the communication unit 22 acquired from the temperature monitoring unit 27 of the communication unit 22 is higher than the threshold Hon (Step S51). When it is determined that the temperature of the communication unit 22 is higher than the threshold Hon (Step S51: Yes), the process proceeds to Step S52. Meanwhile, when it is not determined that the temperature of the communication unit 22 is higher than the threshold Hon (Step S51: No), the process proceeds to Step S53. Note that the cooling ON/OFF determination unit 43 may determine the temperature of the communication unit 22 only for the communication unit 22 in operation.

When it is determined in Step S51 that the temperature of the communication unit 22 is higher than the threshold Hon, the cooling ON/OFF determination unit 43 turns ON the cooling device 32 connected to the communication unit 22 (Step S52). Thereafter, the process proceeds to Step S55.

Meanwhile, when it is not determined in Step S51 that the temperature of the communication unit 22 is higher than the threshold Hon, the cooling ON/OFF determination unit 43 determines whether the temperature of the communication unit 22 is lower than the threshold Hoff (Step S53). When it is determined that the temperature of the communication unit 22 is lower than the threshold Hoff (Step S53: Yes), the process proceeds to Step S54. Meanwhile, when it is not determined that the temperature of the communication unit 22 is lower than the threshold Hoff (Step S53: No), the process proceeds to Step S55.

When it is determined in Step S53 that the temperature of the communication unit 22 is lower than the threshold Hoff, the cooling ON/OFF determination unit 43 turns OFF the cooling device 32 connected to the communication unit 22 (Step S54). Thereafter, the process proceeds to Step S55.

When it is not determined that the temperature of the communication unit 22 is lower than the threshold Hoff in Step S52 or Step S54, or in Step S53, the cooling ON/OFF determination unit 43 determines whether the temperatures of all the communication units 22 in operation have been checked (Step S55). When it is determined that the temperatures of all the communication units 22 in operation have been checked (Step S55: Yes), the process returns to the sequence diagram of FIG. 3 or FIG. 4. Meanwhile, when it is not determined that the temperatures of all the communication units 22 in operation have been checked (Step S55: No), the process returns to Step S51.

Flow of Communication Unit Cooling ON/OFF Determination Processing (3)

A third example of the flow of the communication unit cooling ON/OFF determination processing performed in Step S111 of FIG. 3 and Step S129 of FIG. 4 will be described with reference to FIG. 7C. FIG. 7C is a third flowchart illustrating an example of the flow of the communication unit cooling ON/OFF determination processing performed by the cooling control unit of the antenna device according to the embodiment.

The cooling ON/OFF determination unit 43 causes the temperature monitoring unit 27 of the communication unit 22 to measure the temperature of the communication unit 22 consecutively the number of times M at the determined temperature measurement cycle. Then, the cooling ON/OFF determination unit 43 determines whether the temperature of the communication unit 22 acquired from the temperature monitoring unit 27 of the communication unit 22 is higher than the threshold Hon consecutively M times (Step S61). When it is determined that the temperature of the communication unit 22 is higher than the threshold Hon consecutively M times (Step S61: Yes), the process proceeds to Step S62. Meanwhile, when it is not determined that the temperature of the communication unit 22 is higher than the threshold Hon consecutively M times (Step S61: No), the process proceeds to Step S63. Note that the cooling ON/OFF determination unit 43 may determine the temperature of the communication unit 22 only for the communication unit 22 in operation. Note that the number of times M is an example of a first predetermined number of times in the present disclosure.

When it is determined in Step S61 that the temperature of the communication unit 22 is higher than the threshold Hon consecutively M times, the cooling ON/OFF determination unit 43 turns ON the cooling device 32 connected to the communication unit 22 (Step S62). Thereafter, the process proceeds to Step S65.

Meanwhile, when it is not determined in Step S61 that the temperature of the communication unit 22 is higher than the threshold Hon consecutively M times, the cooling ON/OFF determination unit 43 causes the temperature monitoring unit 27 of the communication unit 22 to measure the temperature of the communication unit 22 consecutively N times at the determined temperature measurement cycle. Then, the cooling ON/OFF determination unit 43 determines whether the temperature of the communication unit 22 acquired from the temperature monitoring unit 27 of the communication unit 22 is lower than the threshold Hoff consecutively N times (Step S63). When it is determined that the temperature of the communication unit 22 is lower than the threshold Hoff consecutively N times (Step S63: Yes), the process proceeds to Step S64. Meanwhile, when it is not determined that the temperature of the communication unit 22 is lower than the threshold Hoff consecutively N times (Step S63: No), the process proceeds to Step S65. Note that the number of times N is an example of a second predetermined number of times in the present disclosure.

When it is determined in Step S63 that the temperature of the communication unit 22 is lower than the threshold Hoff consecutively N times, the cooling ON/OFF determination unit 43 turns OFF the cooling device 32 connected to the communication unit 22 (Step S64). Thereafter, the process proceeds to Step S65.

When it is not determined that the temperature of the communication unit 22 is lower than the threshold Hoff consecutively N times in Step S62 or Step S64, or in Step S63, the cooling ON/OFF determination unit 43 determines whether the temperatures of all the communication units 22 in operation have been checked (Step S65). When it is determined that the temperatures of all the communication units 22 in operation have been checked (Step S65: Yes), the process returns to the sequence diagram of FIG. 3 or FIG. 4. Meanwhile, when it is not determined that the temperatures of all the communication units 22 in operation have been checked (Step S65: No), the process returns to Step S61.

### Operation and Effect of Present Embodiment

As described above, the antenna device 10 according to the present embodiment that is mounted on the vehicle 5 and performs the vehicle-to-vehicle communication and road-to-vehicle communication using the plurality of communication units 22 including the antenna 24, the antenna device includes the communication control unit 26 that is provided in each of the communication units 22 and controls a transmission/reception operation of the antenna 24 connected to the communication unit 22, the vehicle state detection unit 41 that detects the state of the vehicle 5 and the operation state of the communication control unit 26, and the operation control unit 25 that is provided in each of the communication units 22 and controls the operation state of the communication control unit 26 for each of the communication units 22 according to the state of the vehicle 5 detected by the vehicle state detection unit 41 and the operation state of the communication control unit 26. Therefore, the operation state of each communication unit 22 can be switched with an appropriate switching trigger.

Furthermore, in the antenna device 10 according to the present embodiment, the vehicle state detection unit 41 detects that the vehicle 5 is traveling, the traveling place of the vehicle 5, and the operation state of the communication control unit 26, and the operation control unit 25 stops the transmission/reception operation of the communication control unit 26 connected to the predetermined antenna 24 among the plurality of communication control units 26 when the vehicle state detection unit 41 detects that the vehicle 5 is traveling in a closed space such as a tunnel or an underground parking. Therefore, power consumption in the entire communication unit 22 can be reduced. In addition, by reducing the number of communication units 22 made operate, the influence of electromagnetic interference, so-called electromagnetic interference (EMI), electromagnetic sensitivity, so-called electromagnetic susceptibility (EMS) is reduced, and therefore, performance deterioration due to noise can be suppressed.

Furthermore, in the antenna device 10 according to the present embodiment, the operation control unit 25 stops the transmission/reception operation of the antenna 24 connected to the communication control unit 26 on condition that the vehicle state detection unit 41 has determined that communication is unavailable. Therefore, power consumption in the entire communication unit 22 can be reduced.

Furthermore, in the antenna device 10 according to the present embodiment, the vehicle state detection unit 41 further detects that the vehicle 5 is stopped, and the operation control unit 25 stops the transmission/reception operation of the communication control unit 26 connected to the predetermined antenna 24 among the plurality of communication control units 26 when the vehicle state detection unit 41 detects that the vehicle 5 is stopped. Therefore, power consumption in the entire communication unit 22 can be reduced. This makes it possible to suppress shortening of the life of the battery mounted on the vehicle 5.

Furthermore, the antenna device 10 according to the present embodiment further includes the temperature monitoring unit 27 that causes the communication unit 22 in which the communication control unit 26 causes the antenna 24 to perform the transmission/reception operation to monitor the temperature at a predetermined cycle, the cooling ON/OFF determination unit 43 that starts cooling of the communication unit 22 when the temperature monitoring unit 27 detects that the temperature of the communication unit 22 is higher than a first predetermined value, and stops cooling of the communication unit 22 when the temperature monitoring unit 27 detects that the temperature of the communication unit 22 is lower than a second predetermined value that is equal to or less than the first predetermined value; and the cooling control unit 28 that controls the cooling device 32 on the basis of the determination result of the cooling ON/OFF determination unit 43. Thus, only the operating communication unit 22 can be cooled. As a result, it is possible to suppress occurrence of malfunction or failure of the communication unit 22.

Furthermore, in the antenna device 10 according to the present embodiment, when the cooling control unit 28 performs the cooling operation, the temperature monitoring unit 27 shortens the temperature measurement cycle for monitoring the temperature of the communication unit 22 being cooled by the cooling control unit 28 as compared with the cooling control unit 28 stops cooling. Therefore, the temperature rise can be efficiently suppressed for the cooled communication unit 22 among the operating communication units 22.

Furthermore, in the antenna device 10 according to the present embodiment, the first predetermined value is higher than the second predetermined value. Therefore, the cooling of the communication unit 22 can be continued until the temperature of the communication unit 22 is sufficiently lowered.

Furthermore, in the antenna device 10 according to the present embodiment, the cooling ON/OFF determination unit 43 causes the cooling control unit 28 of the communication unit 22 to start cooling when the temperature monitoring unit 27 detects that the temperature of the communication unit 22 is higher than the first predetermined value consecutively a first predetermined number of times, and causes the cooling control unit 28 of the communication unit 22 to stop cooling when the temperature monitoring unit 27 detects that the temperature of the communication unit 22 is lower than the second predetermined value consecutively a second predetermined number of times. Therefore, it is possible to prevent a failure by absorbing a measurement error due to noise or the like and suppressing frequent ON/OFF switching of the cooling device 32. Furthermore, the cooling of the communication unit 22 can be continued until the temperature of the communication unit 22 sufficiently decreases.

According to the antenna device of the present disclosure, the operation state of each communication unit can be switched with an appropriate switching trigger.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An antenna device that is mounted on a vehicle and performs vehicle-to-vehicle communication and road-to-vehicle communication using a plurality of communicators including antennas, the antenna device comprising:
one or more memories; and
one or more hardware processors coupled to the one or more memories,
the one or more hardware processors being configured to function as:
communication control units that are each provided in one of the plurality of communicators and control transmission/reception operations of the antennas connected to the communicators;
a vehicle state detection unit that detects a state of the vehicle and operation states of the communication control units; and
operation control units that are each provided in one of the plurality of communicators and control the operation states of the communication control units according to the state of the vehicle detected by the vehicle state detection unit and the operation states of the communication control units, for each of the plurality of communicators.

2. The antenna device according to claim 1, wherein
the vehicle state detection unit detects that the vehicle is traveling, a traveling place of the vehicle, and the operation states of the communication control units, and
an operation control unit stops a transmission/reception operation of a communication control unit connected to a predetermined antenna among the communication control units when the vehicle state detection unit detects that the vehicle is traveling in a closed space such as a tunnel or an underground parking.

3. The antenna device according to claim 2, wherein
the operation control unit stops the transmission/reception operation of the antenna connected to the communication control unit on condition that the vehicle state detection unit determines that communication is unavailable.

4. The antenna device according to claim 2, wherein
the vehicle state detection unit further detects that the vehicle is stopped, and
an operation control unit stops a transmission/reception operation of a communication control unit connected to a predetermined antenna among the plurality of communication control units when the vehicle state detection unit detects that the vehicle is stopped.

5. The antenna device according to claim 2, wherein the one or more hardware processors are configured to further function as:
a temperature monitoring unit that causes a communicator in which a communication control unit causes an antenna to perform a transmission/reception operation, to monitor a temperature at a predetermined cycle;
a cooling ON/OFF determination unit that starts cooling of the communicator when the temperature monitoring unit detects that the temperature of the communicator is higher than a first predetermined value, and stops cooling of the communicator when the temperature monitoring unit detects that the temperature of the communicator is lower than a second predetermined value that is equal to or lower than the first predetermined value; and
a cooling control unit that controls a cooling device based on a determination result of the cooling ON/OFF determination unit.

6. The antenna device according to claim 5, wherein
when the cooling control unit performs a cooling operation, the temperature monitoring unit shortens a temperature measurement cycle for monitoring the temperature of the communicator cooled by the cooling control unit as compared with when the cooling control unit stops cooling.

7. The antenna device according to claim 5, wherein
the first predetermined value is higher than the second predetermined value.

8. The antenna device according to claim 5, wherein
the cooling ON/OFF determination unit causes the cooling control unit of the communicator to start cooling when the temperature monitoring unit detects that the temperature of the communicator is higher than a first predetermined value consecutively a first predetermined number of times, and causes the cooling control unit of the communicator to stop cooling when the temperature monitoring unit detects that the temperature of the communicator is lower than a second predetermined value consecutively a second predetermined number of times.
